(19) United States
(12) Patent Application Publication
(10) Pub. No.: US 2023/0001692 A1
(43) Pub. Date: Jan. 5, 2023

(54) DROPLET DELIVERY

(71) Applicant: Hewlett-Packard Development Company, L.P., Spring, TX (US)

(72) Inventors: Viktor SHKOLNIKOV, Palo Alto, CA (US); Alexander GOVYADINOV, Corvallis, OR (US)

(73) Assignee: Hewlett-Packard Development Company, L.P., Spring, TX (US)

(21) Appl. No.: 17/782,875

(22) PCT Filed: Feb. 14, 2020
(86) PCT No.: PCT/US2020/018229

§ 371 Date: Jun. 6, 2022

(51) Int. Cl. B41J 2/14

(52) U.S. Cl. CPC B41J 2/14153; B41J 2/14032

(57) ABSTRACT

In example implementations, an apparatus is provided. The apparatus includes a channel, an opening in the channel, and a heating element aligned with the opening on opposite sides of the channel. The channel contains a droplet of a first liquid containing a particle, wherein the droplet is carried within a second liquid in the channel. The heating element is to heat the first liquid to generate a vapor in the first liquid to eject the droplet of the first liquid through the opening.

### BACKGROUND

Droplet microfluidics and digital droplet microfluidics are used to perform sample preparation, single cell isolation, and highly multiplexed chemical reaction assays (e.g., preliminary chain reactions (PCR)). These technologies allow one to compartmentalize a bulk sample into a large number of subsamples and perform detailed analysis on each subsample in an automated fashion.

### BRIEF DESCRIPTION OF THE DRAWINGS

FIG. 1 is a block diagram of an example droplet delivery system of the present disclosure;

FIG. 2 is a cross-sectional block diagram of the droplet delivery apparatus of the present disclosure;

FIG. 3 is a cross-sectional block diagram of the droplet delivery apparatus with stepped bores and sensors of the present disclosure;

FIG. 4 is a cross-sectional block diagram of the droplet delivery apparatus with electrical manipulation of the droplets of the present disclosure;

FIG. 5 is a block diagram of a top view of an example of the droplet delivery apparatus with mechanical manipulation of the droplets of the present disclosure;

FIG. 6 is a block diagram of an example operation of the droplet delivery apparatus of the present disclosure; and

FIG. 7 is a flow chart of an example method for ejecting a droplet from a droplet delivery system of the present disclosure.

### DETAILED DESCRIPTION

Examples described herein provide a system and method for a droplet delivery system. As noted above, droplet microfluidics can be used for a variety of applications. Droplet microfluidics can allow one to compartmentalize a bulk sample into a large number of subsamples and perform detailed analysis on each subsample. However, once compartmentalized it may be difficult to de-compartmentalize the contents of the droplets individually and transfer these contents into wells of a multi-well plate.

The droplet delivery system of the present disclosure provides individual droplet de-emulsification. Moreover, the droplet delivery system can eject many droplets simultaneously into respective wells. As a result, the contents of each droplet can be mapped for various different applications. The droplet delivery system can be used for biological analysis as well as printing applications.

In one example, the droplet delivery system may contain a particle in a droplet of a first liquid that is carried in a second liquid within the droplet delivery system. For example, the second liquid may be in a continuous phase and the first liquid may be dispersed in the second liquid. In an example, the first liquid and the second liquid are immiscible.

The droplet delivery system may use a heating element to create a vapor bubble or steam bubble. The energy released from the steam bubble can be used to eject the droplet of the first liquid through a bore. A minimal or negligible amount of the second liquid may be ejected along with the droplet of the first liquid.

In some examples, the bores may be shaped to help position the droplet over the heating element. Sensors can be used to control operation of the heating element when the droplets are in position over the heating element. In addition, electrical and/or mechanical components can be used to manipulate or steer the droplets toward the bores of the droplet delivery system.

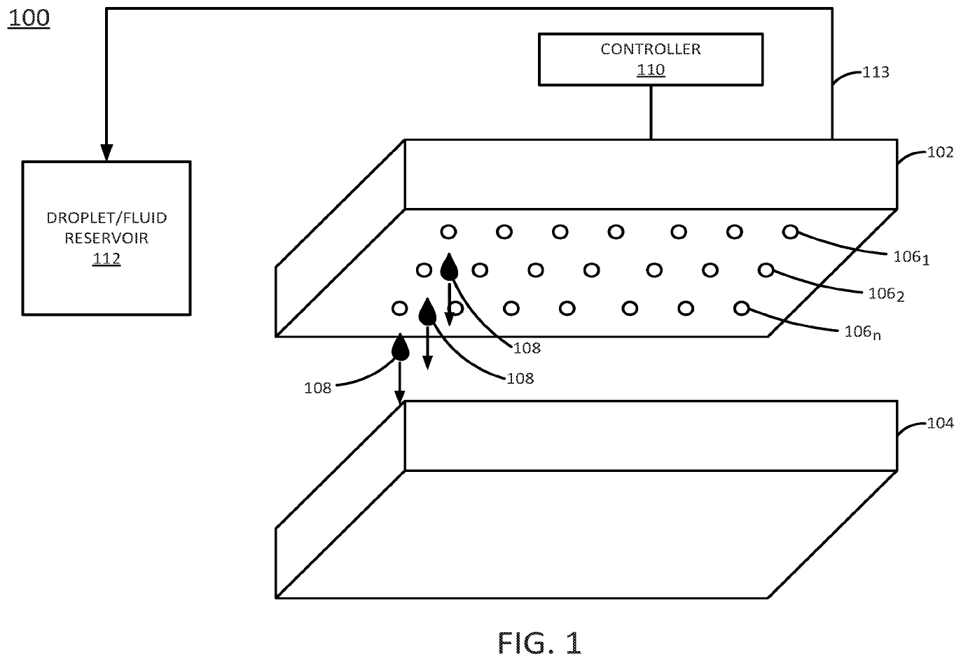

FIG. 1 illustrates an example block diagram of a system 100 of the present disclosure. In an example, the system 100 may include a droplet delivery apparatus 102 (also referred to herein as apparatus 102), an analysis system 104, a droplet/fluid reservoir 112, and a controller 110. In one example, the apparatus 102 may include an interior volume formed by the outer walls of the apparatus 102 (e.g., side wall, top, and bottom). The interior volume may include channels that contain a fluid that carries droplets 108.

In an example, a side of the apparatus 102 may include a plurality of bores or openings 106₁-106ₙ (hereinafter also referred to individually as an opening 106 or collectively as openings 106). The apparatus 102 may include mechanisms (discussed in further details below) that can eject the droplets 108 out of the openings 106 without ejecting the fluid that is in the channels of the apparatus 102. For example, the droplets 108 may be contained in a fluid that is fed through the apparatus 102 from the droplet/fluid reservoir 112.

In an example, the analysis system 104 may be a well plate that may include a plurality of wells. The wells may be aligned with each opening 106 and the droplets 108 may be ejected into respective wells of the well plate. The droplets 108 may then be tracked, sorted, and identified in the well plate.

In another example, the analysis system 104 may be a chamber or volume for further analysis. The droplets 108 may be ejected into an analysis chamber for further observation, processing, or study.

In another example, the analysis system 104 may be another apparatus 102 that contains another fluid to carry the droplets 108 to another section for analysis. In an example, the analysis system 104 may be a combination of the above possibilities. For example, some openings 106 may eject the droplets 108 into well plates, other openings 106 may eject the droplets 108 into an analysis chamber, and other openings 106 may eject the droplets 108 into another section of the apparatus 102 that contains a different fluid for carrying the droplets 108 to another area for analysis. Although the analysis system 104 is shown as being separated from the apparatus 102 for ease of explanation, it should be noted that the analysis system 104 may be part of the apparatus 102.

In an example, the controller 110 may be communicatively coupled to various components within the apparatus 102 to control the ejection of the droplets 108. The controller 110 may control a heating element, sensors, monitoring systems, and the like (discussed in further details below) to eject the droplets 108 out of the openings 106. The controller 110 may selectively eject a droplet 108 out of a particular opening 106, may eject several droplets 108 out of a subset of the openings 106, or may eject droplets 108 out of all of the openings 106 simultaneously.

In an example, the system 100 may include a recirculation loop 113. The recirculation loop may allow droplets 108 that were not trapped by a respective opening 106 to be recirculated through the apparatus 102 until the droplets 108 are trapped adjacent to a respective opening 106. In an example, when the droplets 108 are ready for ejection, the controller 110 may activate a heating element to eject the droplets 108 through the openings 106 and into the analysis system 104, as discussed in further details below.

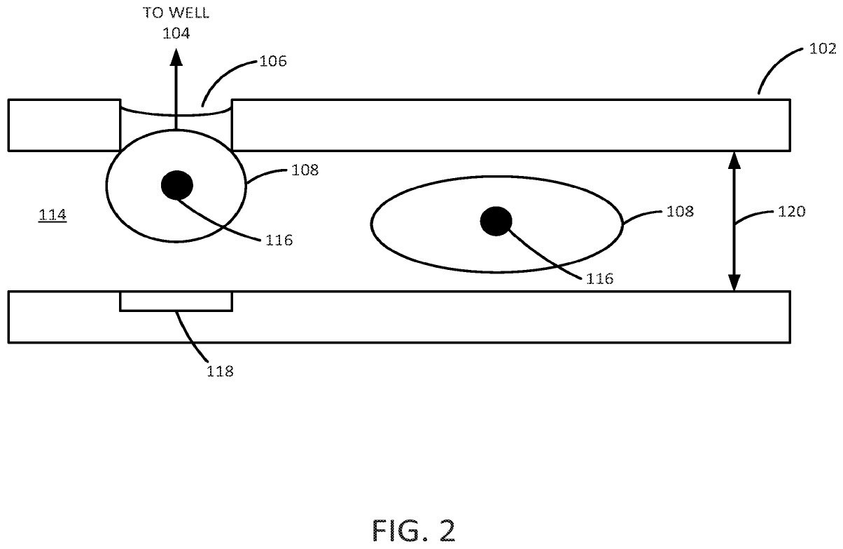

FIG. 2 illustrates an example cross-sectional view of the apparatus 102. FIG. 2 illustrates a channel 120 that is formed between two sides of the apparatus 102. The droplet 108 may be fed through the channel 120 toward an opening 106. In one example, the internal sides of the channel 120 may be hydrophobic. In one example, the sides of the opening 106 may be hydrophilic.

In one example, the droplet 108 may be carried via a fluid 114. The fluid 114 may be a continuous phase liquid and the droplet 108 may be a liquid that is dispersed in the fluid 114. A surfactant may be used to stabilize the droplet 108 in the fluid 114.

In an example, the droplet 108 and the fluid 114 are selected to be different immiscible liquids. For example, the droplet 108 may be a liquid that does not mix with the fluid 114. Examples of immiscible liquids may include water and oil, alcohols in oil, and the like. For example, the droplet 108 may be a water droplet and the fluid 114 may be an oil. Thus, the droplet 108 may flow in the fluid 114 without bursting and mixing into the fluid 114. It should be noted that other types of immiscible fluid combinations can be used.

In an example, the droplet 108 may include a particle 116. The particle 116 may be a biological cell, a print fluid, and the like. The droplet 108 may be used for a variety of different applications depending on the particle 116 that is contained in the droplet 108. For example, the particle 116 may be a cell or biological matter. The droplets 108 may allow for sample preparation, single cell isolation, highly multiplexed chemical reaction assays (e.g., polymerase chain reactions), and the like.

In another application, the particle 116 may include unstable print fluids. For example, the pint fluids may include a suspension of particles including pigment particles, unstable suspensions, or particle slurries. The print fluids may be ejected without the surrounding oil in precise amounts. As a result, the print fluid may dry faster as less fluid overall is dispensed.

In an example, the droplet 108 may flow toward the opening 106 via a variety of different mechanisms. In an example, the droplet 108 may be drawn towards the opening 106 via a “cheerios” effect caused by the surface tension of the droplet 108 and the surface tension of the fluid 114 at the opening 106. For example, the opening 106 may cause the fluid 114 to form a meniscus against the walls of the opening 106.

In addition, the gradual evaporation of the fluid 114 at the opening 106 may cause the fluid 114 to flow towards the opening 106, thereby also drawing the droplet 108 towards the opening 106. When the droplet 108 encounters the meniscus at the opening 106, capillary forces of the meniscus may pull the droplet 108 towards an immobile part of the meniscus (e.g., a portion of the meniscus against the sidewalls of the opening 106). In other examples, discussed herein, mechanical and electrical devices can be used to manipulate the movement of the droplets 108 within the channel 120.

When the droplet 108 arrives at the opening 106, the droplet 108 may be attracted to the sidewalls of the opening 106. The droplet 108 may be positioned to be aligned with a heating element 118. The heating element 118 may be aligned with the opening 106 and be located on an opposite side of the channel 120 relative to the opening 106. In other words, if the opening 106 is on a top side of the channel 120, then the heating element 118 may be located on a bottom side of the channel 120 opposite the opening 106. In an example, the heating element 118 may be aligned such that a center of the heating element 118 may be approximately aligned with a center of the opening 106.

In an example, the heating element 118 may be any type of energy source that can locally heat the liquid of the droplet 108. For example, the heating element 118 may be an inductive heater or a thermal inkjet (TIJ) resistor. In an example, the TIJ resistor may include a controllable circuit that includes a resistor heater. When the circuit is activated, current may flow through the resistor heater to generate heat.

In an example, the droplet 108 dispersed in the fluid 114 may be selected to be a liquid that can be easily jetted by the TIJ resistor when the heating element 118 is a TIJ resistor. Examples of liquids for the droplet 108 that can be easily jetted by the TIJ resistor may include water, alcohols, and the like.

In an example, the heat generated by the heating element 118 may create vapor bubbles in the liquid of the droplet 108 near the heating element 118. The vapor bubbles may move the droplet 108 towards the opening 106. As the vapor bubbles burst, the force exerted by the bursting vapor bubbles may eject the droplet 108 out of the opening 106.

However, the fluid 114 may have a vapor pressure that is lower than the vapor pressure of the liquid used to form the droplet 108. Alternatively, the fluid 114 may have a boiling point that is higher than a boiling point of the liquid that forms the droplet 108. Thus, the heat flux generated by the heating element 118 is to be such that the heat flux is not enough to input power into the fluid 114, but enough to input sufficient power into the droplet 108 to generate an expanding vapor bubble in the droplet 108. As a result, the expanding vapor bubble may have sufficient momentum to push the droplet 108 out of the opening 106. Thus, the droplet 108 may be ejected without ejecting any, or a very minimal amount, of the fluid 114. In other words, the apparatus 102 may provide an efficient de-emulsification of the droplet 108 from the fluid 114 for a variety of different applications.

The diameter or size of the opening 106 may be a function of the size of the droplets 108. The diameter of the opening 106 may also be selected to form a desired meniscus of the fluid 114 without allowing the fluid 114 to escape. Thus, the diameter of the opening 106 may be sized to allow the droplets 108 to be ejected through the opening 106, but not large enough to allow the fluid 114 to freely flow out of the opening 106.

In an example, the diameters of the individual openings 106 may be the same size. In another example, the diameter of the openings 106 may be different sizes. For example, different sized droplets 108 may be fed into the fluid 114 and through the channel 120. The different sized diameters of the openings 106 may be used to capture different sized droplets 108 for ejection in a non-homogeneous emulsion of droplets 108 in the fluid 114.

In an example, the controller 110 may be communicatively coupled to the heating element 118. In an example, a respective heating element 118 may be aligned with each opening 106₁ to 106ₙ. The controller 110 may independently control each heating element 118. As a result, when a droplet 108 is to be ejected from a particular opening 106₁ to 106ₙ the controller 110 may activate the respective heating element 118 to eject the droplet 108 from the desired opening or openings 106₁ to 106ₙ.

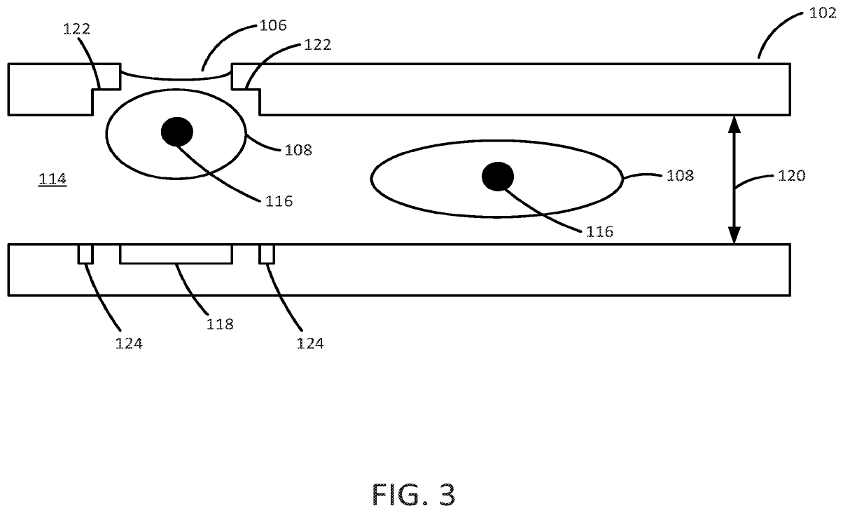

FIG. 3 is a block diagram of a cross-sectional view of the example cell trapping array with the TIJ resistor array and a sensor of the present disclosure. In an example, the opening 106 may include features 122 to trap the droplet 108. The features 122 may be mechanical features. For example, the opening 106 may include a cut-out, an indentation, or a stepped bore. As the droplet 108 moves towards the opening 106, the droplet 108 may expand into the large volume created by the features 122 and be temporarily trapped between the opening 106 and the heating element 118. Although the features 122 are illustrated as rectangular shaped cut-outs, it should be noted that the features 122 may be any shape.

Although the features 122 are illustrated as being on a top side of the channel 120 near the opening 106, it should be noted that the features 122 may also be on a bottom side of the channel 120 near the heating element 118. For example, a cut out may be added around the heating element 118. In one example, the features 122 may be located on both a top side and a bottom side of the channel 120.

In one example, the droplet 108 may be trapped by changing a surface contact angle of the droplet 108 to the sidewalls of the opening 106. For example, features 122 can be used to change the surface contact angle, or other methods (e.g., electrical manipulation of the contact angle via electrodes) may be used.

In an example, the apparatus 102 may also include a sensor 124. The sensor 124 may be an impedance sensor or a capacitive sensor. In other examples, the sensor 124 may be an optical sensor. For example, the channel 120 may be illuminated near the openings 106 such that an optical sensor can capture images of the opening 106. The images can be analyzed to determine the droplet 108 is present near the opening 106.

The sensor 124 may be communicatively coupled to the controller 110. The sensor 124 may send a signal to the controller 110 when the droplet 108 is detected by the sensor. The controller 110 may then activate the heating element 118 to eject the droplet 108 in response to receiving the signal from the sensor 124.

In an example, the sensor 124 may be positioned to detect when the droplet 108 is aligned with the opening 106 and the heating element 118. For example, the sensor 124 may be located around the heating element 118. In another example, the sensor 124 may be located above the heating element and around the opening 106.

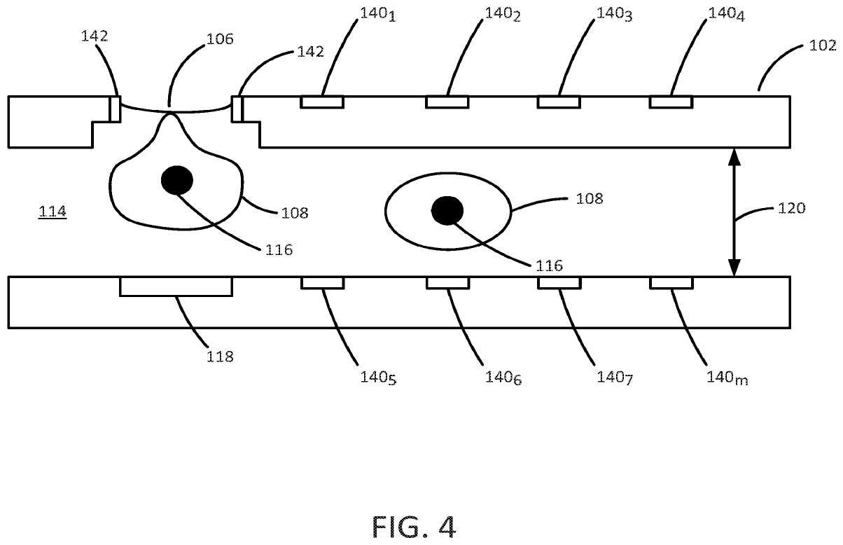

FIG. 4 illustrates a cross-sectional block diagram of the apparatus 102 with electrical manipulation of the droplets 108 of the present disclosure. In an example, electrodes 140₁ to 140ₘ (hereinafter also referred to individually as an electrode 140 or collectively as electrodes 140) may be coupled to, or formed into, the top side and/or the bottom side of the channel 120. For example, the channel 120 may include electrodes 140₁-140₄ on the top side, may include electrodes 140₅-140ₘ on the bottom side, or may include both electrodes 140₁-140₄ on the top side and electrodes 140₅-140ₘ on the bottom side.

In an example, the electrodes 140 may be communicatively coupled to the controller 110. The controller 110 may control activation of the electrodes 140 to manipulate movement of the droplets 108 through the channel 120. For example, the electrodes 140 may be part of an electrowetting-on-dielectric (EWOD) or an electrowetting-on-conductor (EWOC) system that can move the droplets 108 into position below the opening 106.

In an example, the apparatus 102 may also include electrodes 142 located on sidewalls of the opening 106. For example, multiple electrodes 142 may be located along the sidewall of the opening 106 or a single electrode 142 may be located all the way around the sidewall of the opening 106.

In an example, the electrode(s) 142 may be communicatively coupled to the controller 110. The controller 110 may control the activation of the electrode(s) 142. The electrode(s) 142 may be activated to manipulate a shape of the droplet 108. In an example, the controller 110 may activate the electrode(s) 142 in response to receiving a signal from the sensors 124 illustrated in FIG. 3, and discussed above. The electrode(s) 142 may be activated to change a contact angle of the droplet 108 to the meniscus formed by the fluid 114 at the opening 106. For example, the electrode(s) 142 may be activated to shape the droplet 108 to be narrower. This may allow the droplet 108 to be ejected more easily through the opening 106.

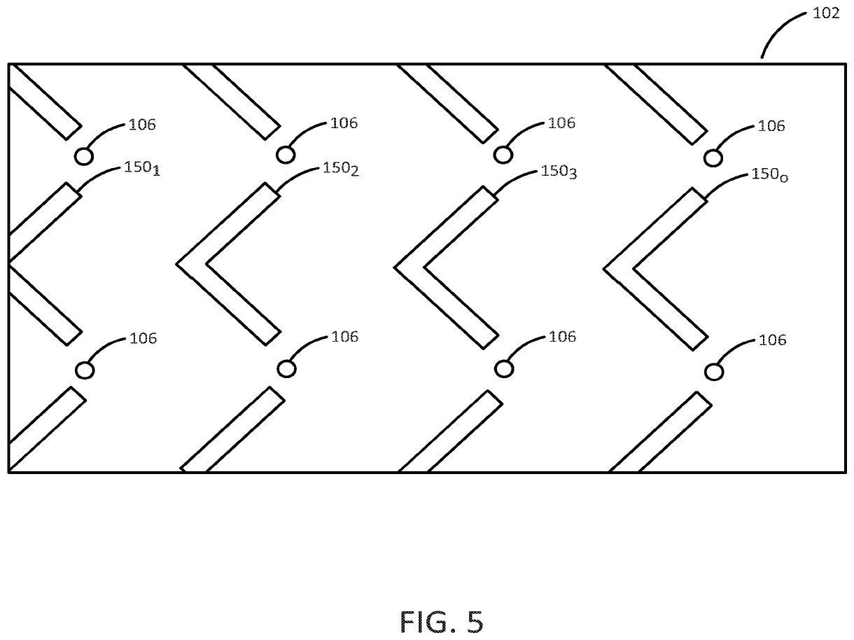

FIG. 5 illustrates a top view of an example of the apparatus 102 with mechanical manipulation of the droplets of the present disclosure. In an example, the apparatus 102 may include physical structures 150₁ to 150ₒ (hereinafter also referred to individually as a physical structure 150 or collectively as physical structures 150). The physical structures 150 may be located within the channel 120 of the apparatus 102 and located between the openings 106. The physical structures 150 may help guide the droplets 108 through the channel 120 to an opening 106.

In one example, the physical structures 150 may be coupled to the top side and the bottom side of the channel 120. In one example, the physical structures 150 may be coupled to a top side of the channel 120. In one example, the physical structures 150 may be coupled to a bottom side of the channel 120.

FIG. 5 illustrates an example where the physical structures 150 are shaped as chevrons. The shape of the chevrons can help to guide the droplets 108 towards an opening 106. However, it should be noted that the physical structures 150 may include other shapes. For example, the physical structures 150 may include half-moons, triangles, polygons, arrays of pillars, and the like.

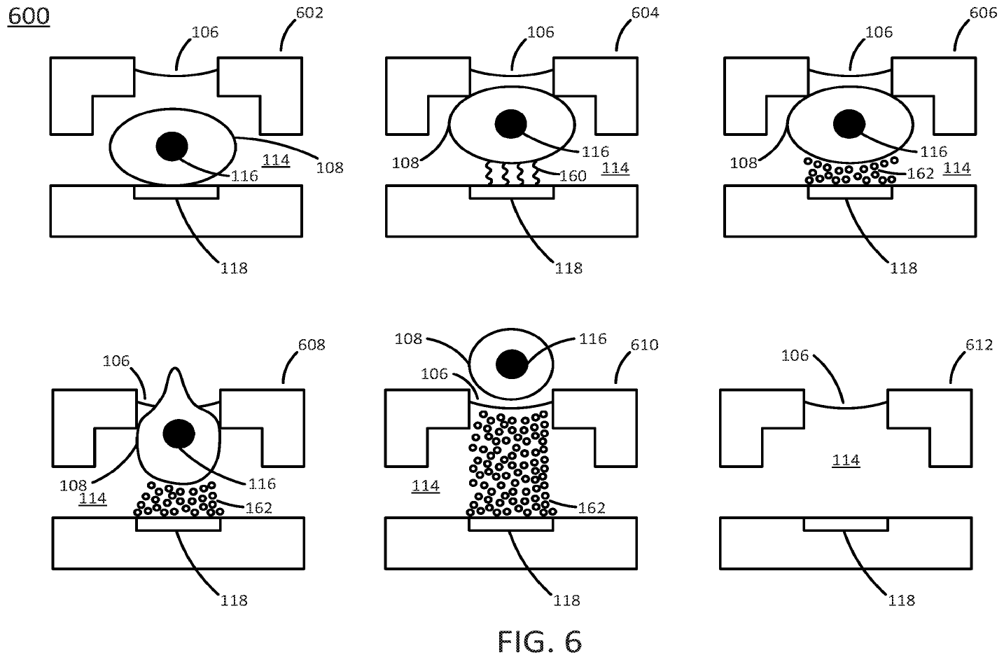

FIG. 6 illustrates a block diagram of an example operation of the droplet delivery apparatus 102 of the present disclosure. At block 602, a droplet 108 may be trapped below an opening 106. The droplet 108 may be trapped such that the droplet 108 is located between a heating element 118 and the opening 106. The droplet 108 may be trapped using mechanical features, such as features 122 illustrated in FIG. 3, and discussed above.

In an example, the droplet 108 may be moved through the channel 120 towards the opening 106 through the cheerios effect and/or evaporation of the fluid 114 out of the opening 106. In other examples, the droplet 108 may be moved via electrical manipulation (e.g., the electrodes 140 illustrated in FIG. 4, and discussed above) or via mechanical manipulation (e.g., the physical structures 150 illustrated in FIG. 5, and discussed above).

At block 604, the heating element 118 may be activated. In an example, sensors 124 may be used to detect the presence of the droplet 108. The sensors 124 may transmit a detection signal to the controller 110. In response, the controller 110 may activate the heating element 118. The heating element 118 may be an inductive heater of a TIJ resistor heater. The heating element 118 may begin to generate heat 160 to heat a thin layer of liquid of the droplet 108.

At block 606, the heat 160 may cause vapor bubbles 162 to be formed in a thin layer of the liquid of the droplet 108. The vapor bubbles 162 may begin to push the droplet 108 and the particle 116 inside of the droplet 108 towards the opening 106.

In an example, the opening 106 may include an electrode 142 that can be activated to manipulate the shape of the droplet 108 as illustrated in FIG. 4 and discussed above. The electrode 142 may be activated by the controller 110. Manipulating the shape of the droplet 108 may help the droplet 108 to be ejected through the opening 106 more efficiently.

At block 608, as the vapor bubbles 162 are formed and burst, the energy released by the vapor bubbles 162 may force the droplet 108 through the opening 106. The vapor bubbles 162 may form a jet that moves the droplet 108 with enough force to eject the droplet 108. However, since the fluid 114 has a lower vapor pressure than the liquid of the droplet 108, the vapor bubbles may not be generated in the fluid 114 by the heating element 118.

At block 610, the droplet 108 may be ejected through the opening 106. The droplet 108 may be maintained out of the apparatus 102 (e.g., in air as the droplet 108 falls into a respective well of well plate, e.g., as illustrated in FIG. 1 and discussed above. Notably, the fluid 114 may not be ejected (or a minimal amount) may be ejected through the opening 106 with the droplet 108.

At block 612, the heating element 118 may be deactivated. The vapor bubbles 162 may collapse and the opening 106 may be ready to accept another droplet 108.

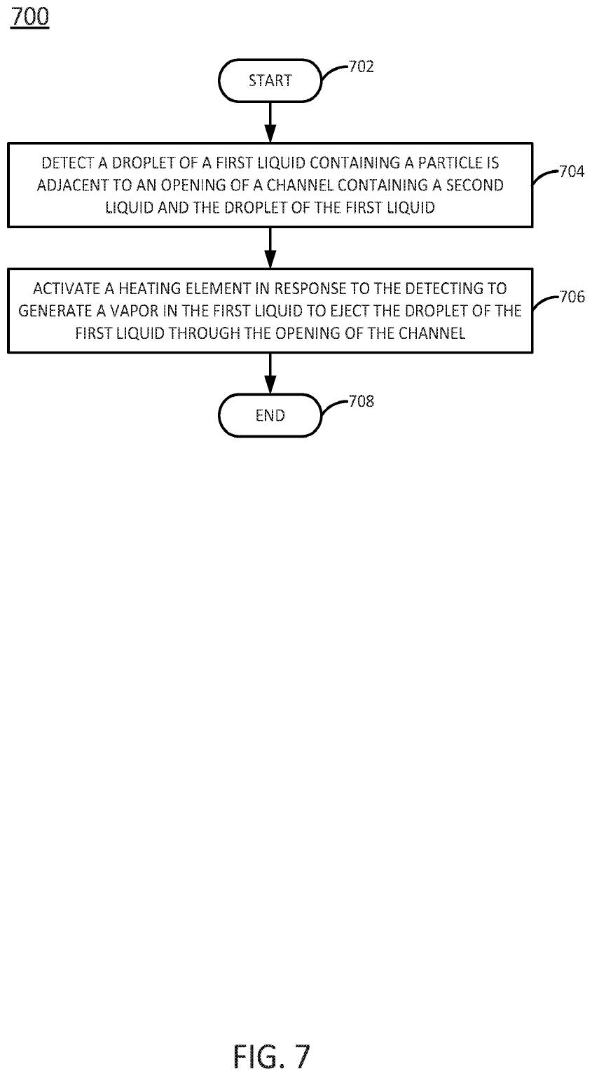

FIG. 7 illustrates a flow diagram of an example method 700 for ejecting a droplet from a droplet delivery system of the present disclosure. In an example, the method 700 may be performed by the apparatus 102.

At block 702, the method 700 begins. At block 704, the method 700 detects a droplet of a first liquid containing a particle is adjacent to an opening of a channel containing a second liquid and the droplet of the first liquid. In an example, the first liquid and the second liquid may be different liquids that are immiscible. In other words, the first liquid may not be homogenously mixed into the second liquid. Examples of the first liquid may be water or a solvent and the second liquid may be oil.

In an example, a sensor may be used to detect the presence of the droplet. The sensor may be located near the opening (e.g., adjacent to the opening or on an opposite side of the opening).

In an example, the block 704 may be performed for a plurality of different droplets. For example, different droplets to be ejected may be detected to be adjacent to respective openings of a plurality of different openings. In an example, the different droplets can be tracked through the droplet delivery system to respective particular openings. As a result, when the droplets are ejected, the droplets can be identified in respective wells of a well plate that receives the droplets.

At block 706, the method 700 activates a heating element in response to the detecting to generate a vapor in the first liquid to eject the droplet of the first liquid through the opening of the channel. For example, the heating element may generate vapor bubbles. The energy released by bursting of the vapor bubbles may generate a jet that moves the droplet towards the opening with enough force to eject the droplet through the opening. The heating element may be an inductive heating element or a TIJ resistor heater, as described above.

In an example, where a plurality of droplets is detected in block 704, the method 700 may repeat the block 706. In an example, the block 706 may be repeated until each one of the droplets is ejected. In an example, the block 706 may be performed simultaneously for a plurality of different droplets. In other words, the plurality of different droplets can be ejected simultaneously rather than at different times or in serial. At block 708, the method 700 ends.

It will be appreciated that variants of the above-disclosed and other features and functions, or alternatives thereof, may be combined into many other different systems or applications. Various presently unforeseen or unanticipated alternatives, modifications, variations, or improvements therein may be subsequently made by those skilled in the art which are also intended to be encompassed by the following claims.

1. An apparatus, comprising:
a channel containing a droplet of a first liquid containing a particle, wherein the droplet is carried within a second liquid in the channel;
an opening in the channel; and
a heating element aligned with the opening on opposite sides of the channel, wherein the heating element is to heat the first liquid to generate a vapor in the first liquid to eject the droplet of the first liquid through the opening.

2. The apparatus of claim 1, wherein the first liquid and the second liquid are immiscible.

3. The apparatus of claim 1, wherein a vapor pressure of the second liquid is lower than a vapor pressure of the first liquid or a boiling point of the second liquid is higher than a boiling point of the first liquid.

4. The apparatus of claim 1, wherein the channel comprises a stepped bore around the opening or the heating element to trap the droplet adjacent to the opening.

5. The apparatus of claim 1, wherein a contact angle of the droplet against a sidewall of the opening is changed to trap the droplet adjacent to the opening.

6. The apparatus of claim 1, wherein the opening comprises at least one electrode to shape the droplet to be ejected.

7. The apparatus of claim 1, wherein the heating element comprises a thermal inkjet (TIJ) resistor.

8. An apparatus, comprising:
a channel containing a droplet of a first liquid containing a particle, wherein the droplet is carried within a second liquid in the channel;
an opening in the channel;
a sensor to detect that the droplet is aligned with the opening; and
a heating element aligned with the opening on opposite sides of the channel, wherein the heating element is to heat the first liquid to generate a vapor in the first liquid to eject the droplet of the first liquid through the opening in response to the sensor detecting the droplet.

9. The apparatus of claim 8, wherein the sensor comprises an impedance sensor or a capacitive sensor.

10. The apparatus of claim 8, further comprising:
a plurality of electrodes located along a wall of the channel to manipulate movement of the droplet through the channel to the opening.

11. The apparatus of claim 8, further comprising:
a plurality of structures located inside of the channel to manipulate movement of the droplet through the channel to the opening.

12. The apparatus of claim 8, wherein the heating element comprises a thermal inkjet (TIJ) resistor.

13. A method, comprising:
detecting a droplet of a first liquid containing a particle is adjacent to an opening of a channel containing a second liquid and the droplet of the first liquid; and
activating a heating element in response to the detecting to generate a vapor in the first liquid to eject the droplet of the first liquid through the opening of the channel.

14. The method of claim 13, wherein the detecting and the activating are performed for a plurality of different droplets at a plurality of different openings of the channel.

15. The method of claim 14, wherein the plurality of different droplets is tracked through the channel and individual droplets of the plurality of different droplets are identified in respective wells of a well plate that receives the plurality of different droplets that are ejected.
